(19) United States
(12) Patent Application Publication
(10) Pub. No.: US 2024/0133833 A1
(43) Pub. Date: Apr. 25, 2024

(54) SYSTEMS AND METHODS OF MEASURING A CONCENTRATION OF VOLATILE CORROSION INHIBITORS

(71) Applicant: Northern Technologies International Corporation, Circle Pines, MN (US)

(72) Inventors: Juan Manuel Dominguez Olivo, Shaker Heights, OH (US); Terry Alan Natale, Hudson, OH (US); Gautam Ramdas, Beachwood, OH (US)

(21) Appl. No.: 18/049,505

(22) Filed: Oct. 24, 2022

(51) Int. Cl. G01N 27/12; F17D 5/00; G01N 1/20

(52) U.S. Cl. CPC G01N 27/12; F17D 5/00; G01N 1/20

(57) ABSTRACT

Systems and methods are disclosed to measure the concentration of volatile corrosion inhibitors (VCI) in a liquid, optionally, in an injection system, pipe casing of an underground pipe, or other enclosed system where VCI is present.

### FIELD OF THE DISCLOSURE

The disclosure relates to systems and methods of measuring a concentration of volatile corrosion inhibitors in a system using a VCI sensing device incorporating a chemoresistor sensor. The systems and methods may include a chemoresistor sensor, a data acquisition board, and a flexible transmission wire, and optionally, an injection line, a port, or a pipe.

### BACKGROUND OF THE DISCLOSURE

The oil and gas industry relies on volatile corrosion inhibitors (VCI) to protect confined assets where atmospheric corrosion can occur, such as storage tanks from soil-side corrosion, pipe casings and other confined assets. In the case of tanks, VCI is injected in liquid form from below or under the storage tank. The VCI moves into the airspace between the hard sand pad beneath the storage tank and the storage tank itself. In casings, the inhibitor is typically injected as a multiphase corrosion-inhibiting gel filler as per the NACE standard practice SP0200-2014, Appendix A3. The volatile corrosion inhibitor diffuses and provides corrosion mitigation in void spaces within the annular space of the casing

Electrical resistance (ER) probes are often used to determine the corrosivity (in terms of corrosion rate) of the environment and assess the level of VCI present for corrosion protection. However, there are limitations to the usefulness of ER probes, such as will be described. The effectiveness of the VCI depends on its diffusion through airspace to the metal substrate. The rate of diffusion is also a limiting factor, even as the VCI is present in the storage tank or annulus space of a casing, the effects of the corrosion inhibitor is not observed by the ER probes until at least a month after the injection. Therefore, there is a gap in time between injection and the initial determination if the VCI was present in the system is providing adequate protection.

There is a need for a faster and more reliable test for the presence and concentration of VCI.

### SUMMARY OF THE DISCLOSURE

A VCI sensing device is disclosed including a sensing element containing a chemoresistor sensor; a data acquisition board; and a flexible transmission wire coupled at one end to the sensing element and coupled at the other end to the data acquisition board. The chemoresistor sensor may include a heating element, and optionally a sensing circuit. The chemoresistor sensor may be calibrated to measure the concentration of VCI in the system. A load resistance in the chemoresistor sensor may change based on a concentration of VCI in the system, and the data acquisition board may convert the load resistance to a measurement of the concentration of VCI.

A VCI sensing head for measuring a concentration of VCI is disclosed. The VCI sensing head includes a VCI sensing device, a plurality of valve and a plurality of piping. The sensing element may be enclosed within the piping. The sensing head may be configured to be attached to an enclosed system containing VCI. The plurality of valves may include one or more of a valve to sensor, a valve to air space, a bleeding valve and a manifold valve. The VCI sensing head may be configured to be connected to one or more measuring lines of an injection system.

A VCI measuring system for an injection system is disclosed including: injection lines, wherein each of the injection lines has a circular portion and a plurality of linear portions; measuring lines, wherein each of the measuring lines has a circular portion and a linear portion; an injection manifold coupled to the linear portions of the injection lines and the linear portion of the one or more measuring lines; ana a VCI sensing head or VCI sensing device. The chemoresistor sensor comprises a heating element.

A VCI measuring system for a pipe casing is disclosed including: a pipe casing surrounding an underground pipe, wherein the pipe casing includes one or more vents; and a VCI sensing device. The sensing element may be positioned within one of the vents and is positioned in close proximity to the pipe casing and may be configured to measure the amount of VCI within the pipe casing.

A method of measuring a concentration of VCI in an injection system is disclosed. That method includes: injecting a liquid containing VCI into a sand bed; diffusing the VCI in a measuring line within the sand bed; driving the VCI by convection from the measuring line into a head containing a chemoresistor sensor; calculating a voltage drop in the chemoresistor sensor; and converting the voltage drop into the measurement of the concentration of VCI. A method of measuring a concentration of VCI in a pipe casing is also disclosed and may include: inserting a sensing element coupled to a flexible transmission wire into a vent connected to the pipe casing, wherein the sensing element includes a chemoresistor sensor; calculating a voltage drop in the chemoresistor sensor due to the presence of VCI in the pipe casing; and converting the voltage drop into the concentration of VCI.

### DESCRIPTION OF THE FIGURES

FIG. 1 is a block diagram of a VCI measuring system of how information flows through the chemoresistor sensor and data acquisition board.

FIG. 2A is a VCI measuring device. FIG. 2B is a VCI measuring system showing the VCI measuring device within a system.

FIG. 3 is a digitalized master curve for calibration according to the MQ-135 vendor, a chemoresistor sensor.

FIG. 4 is an image generated with Tinkercad Autodesk™ showing connection between the chemoresistor sensor and data acquisition board.

FIG. 5 is an image generated with Tinkercad Autodesk™ showing a circuit utilized for the gas detector with a 9V battery and a data acquisition board.

FIG. 6 is a drawing showing a heating circuit, and a sensing circuit with a chemoresistor sensor.

FIGS. 7A and 7B depicts a separation of the sensing circuit of FIG. 6 from the heating circuit to perform calculations and a further calibration.

FIG. 8 is a pictorial representation of a data acquisition board with sensor.

FIGS. 9A and 9B is drawing of a sensing head.

FIG. 10 is a cross-sectional view of the sensing head of FIG. 9.

FIG. 11 is a VCI measuring system including a head connected to the manifold of an injection system.

FIG. 12 shows a step of bleeding the system to avoid damaging the sensor. Arrows indicate the flow of the liquid bleeding from the measuring line before measuring the VCI.

FIG. 13 shows a step of opening the valve to the sensing element to permit measuring. Arrows represent the flow of air containing the VCI from the measuring line

FIG. 14 is a VCI measuring system for an injection system.

FIG. 15 is an injection system which includes a corrosion inhibitor and is conventionally placed beneath a tank.

FIG. 16 is an injection manifold coupled to measuring lines in an injection system.

FIG. 17 is a VCI measuring system in a pipe casing surrounding an underground pipe. The dashed line represents a flexible transmission wire

FIG. 18 is enhanced detail of the VCI measuring system in a pipe casing of FIG. 17.

FIG. 19 is a drawing showing an experimental setup to validate accuracy of the VCI sensing device.

FIG. 20 is a graph showing ammonia levels in the test sample measured by the chemoresistor sensor and the colorimetric tube, and relative error of about 3%.

### DETAILED DESCRIPTION OF THE DISCLOSURE

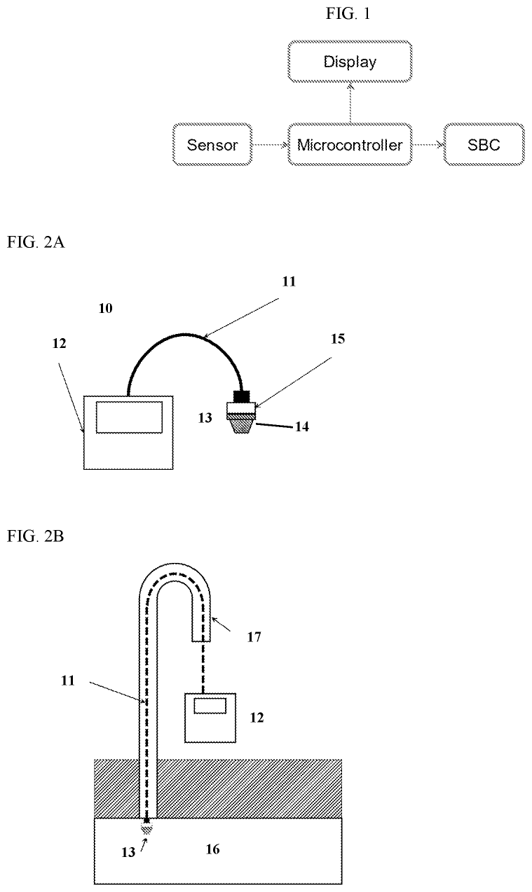

A VCI sensing device may include a sensing element connected to a data acquisition board (microcontroller) by any means known in the art, for example, by a flexible transmission wire, 802.11n wireless technology, Bluetooth, etc. The sensing element is connected to a data acquisition board which may include a microcontroller and a single board computer (SBC). The microcontroller shows real-time data through a display. The SBC governs the frequency of data acquisition of the microcontroller and functions as a datalogger. A block diagram of the sensor system is shown in FIG. 1.

As shown in FIGS. 2A and 2B, the VCI sensing device may be adjusted (e.g., via length of the transmission wire) to reach any space that contains an injected liquid that produces VCI. The VCI sensing device may reach the space by insertion of the sensing element via a vent or any point of access to the space such as a line detection port, an ER probe port, an unused injection line, etc. As an example of injected liquids, solutions of benzotriazole (BTA), dicyclohexyl ammonium nitrite (DICHAN), diisopropyl ammonium benzoate (DICHA BA), etc. (see: Three Bond, “Volatile Corrosion Inhibitor (VCI),” Tech. News, July, no. 18, pp. 1-10, 1987.) are commonly injected in enclosed systems to provide protection. After dispersing through the voids in a confined space, the VCI diffuses towards the sensing element, which optionally may be within a head to protect the sensing element. The head may contain the chemoresistor sensor, and the chemoresistor sensor measures the concentration of the VCI. The VCI may be measured by the chemoresistor sensor which includes a gas sensor, e.g., a metal oxide semiconductor gas sensor, that changes its resistance in the presence of certain gases, in this system, a VCI.

The sensing element may include a chemoresistor sensor and a socket or circuit board by with to attach the chemoresistor sensor to a flexible data transmission wire, and hold it in place. The socket may be a phoenix socket. The circuit board may be a MQ board or any other circuit board of similar size known in the art. FIGS. 2A and B illustrate the general concept of the VCI sensing device. The VCI sensing device 10 of FIG. 2A includes a data acquisition board 12, a flexible data transmission wire 11, and a sensing element 13. The sensing element 13 includes a chemoresistor sensor 14 and a socket 15. The VCI sensing device 10 of FIG. 2A includes a data acquisition board 12, a sensing element 13 placed within a confined space 16, and a flexible data transmission wire 11 inserted through a vent 17.

The chemoresistor sensor measures the concentration of VCI and improves the detection rate over conventional methods by providing a faster and more reliable measurement of the presence of corrosion inhibitor. The chemoresistor sensor employed herein is able to provide an exact measurement rather than a qualitative reading (e.g., low/medium/high) as conventionally provided. In this way, the systems and methods disclosed herein provide faster and more accurate VCI measurements than conventional methods of detection, while also avoiding previously known issues, such as formation of condensation within the chemoresistor sensor or head.

The chemoresistor sensor may be any air quality and gas sensor that is suitable for measuring gases such as, NH₃, NOx, alcohol, benzene, smoke, and/or CO₂. The chemoresistor sensor may be small so that it is versatile and able to fit into small sampling ports. A small chemoresistor sensor may be less than about 50 mm in length, width, and height. A small chemoresistor sensor may be about 30 mm to about 50 mm in length, about 15 to about 50 mm in width, and about 15 mm to about 50 mm in height, or about 35 mm×about 22 mm×about 23 mm (length×width×height). The chemoresistor sensor may have a working voltage of: DC 5 V. The chemoresistor sensor may have high accuracy, broad detection range, and store in-situ data to be analyzed further ex-situ. The term “about” as used herein may be defined as ±10%.

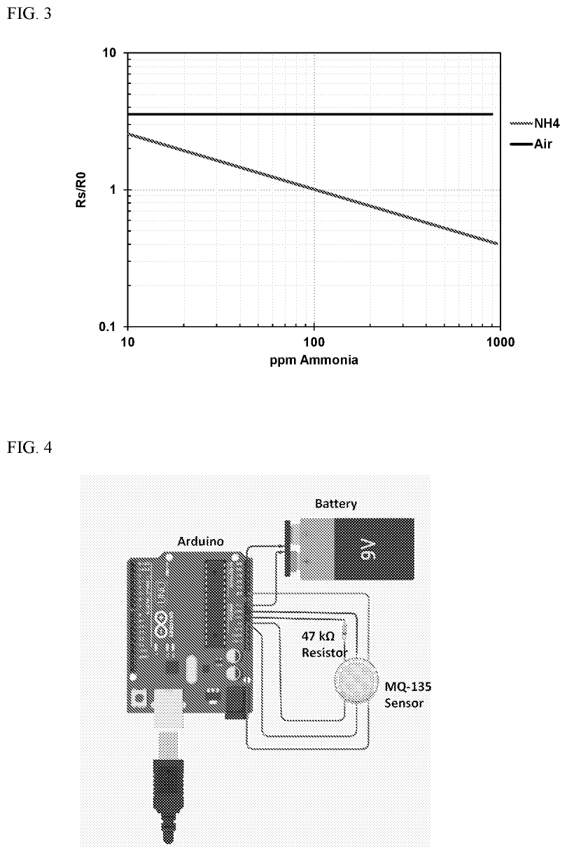

The chemoresistor sensor may be a commercial MQ-135 sensor. Details of the commercial MQ-135 sensor and a calibration master curve are provided in the manufacturer's website (https://www.winsen-sensor.com/d/files/PDF/Semiconductor%20Gas%20Sensor/MQ135%20(Ver1.4)%20-%20Manual.pdf). FIG. 3 shows a digitalized master curve for ammonia (VCI main component). In that curve, the ratio of Rs/R₀ is plotted against the concentration of ammonia and air. The value R₀ corresponds to the resistance of the sensor in the presence of 100 ppm of ammonia. Rs corresponds to the resistance value of the sensor at any concentration of ammonia.

As research has demonstrated, a microcontroller can be used to detect the change in the ratio of resistance by means of potential drop and Ohm's law (See: F. Dodigović, et al., “Ammonia concentration monitoring using Arduino,” Environ. Eng., vol. 6, no. 1, pp. 21-26, 2019, doi: 10.37023/ee.6.1.4; D. Hofstetter, et al., “Ammonia generation system for poultry health research using arduino,” Sensors, vol. 21, no. 19, pp. 1-20, 2021, doi: 10.3390/s21196664; D. Hofstetter, et al., “Update on ammonia generator for maintaining a set indoor gas concentration for poultry health research,” Am. Soc. Agric. Biol. Eng. Annu. Int. Meet. ASABE 2021, vol. 3, pp. 1781-1787, 2021, doi: 10.13031/aim.202100667.)

The microcontroller, also referred to as a data acquisition board, may be any microcontroller board having digital input/output pins, analog inputs, a ceramic resonator, a USB connection, a power jack, an ICSP header and a reset button. The data acquisition board may contain all components that are required to support the microcontroller, or any other microcontroller or data acquisition board capable of reading inputs and turn it into an output, e.g., activating a motor, turning on an LED, publishing something online. The microcontroller may be an Arduino Uno®. According to official documentation, the Arduino Uno® contains an integrated 10-bit analog to digital converter and an operating voltage of 3.3 or 5 V (https://www.arduino.cc/reference/en/language/functions/analog-io/analogread/). This implies that the Arduino® can read a potential drop up to 5 V and convert the value into numbers between 0 and 1023 (hereafter A₀). The wiring is shown in detail in FIG. 4 and FIG. 5. The elements of the sensor are explained in detail as follows.

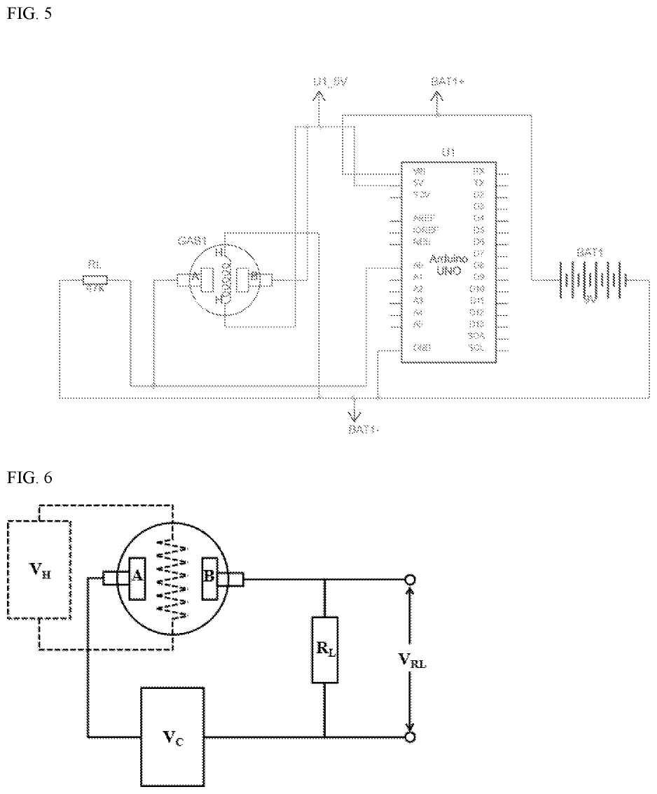

The chemoresistor sensor may include a heating element. The chemoresistor sensor may include a heating circuit and a sensing circuit, as depicted in FIG. 6 which shows a sensor having integrated circuits in greater detail.

It was found that introduction of the heating element creates forced convection in a system. The temperature differential created between the heating element (reaching up to 60° C.) and the bottom of the tank drives the VCI out of the sand in an injection system. This creates movement of the air that helps to move the VCI from the bottom to the head; thus, decreasing the time to measure the VCI. In addition, the heating element reduces or eliminates condensation in the sensor and damage to the sensing element. In FIG. 6, V_{H} stands for voltage applied to the heating element, V_{C} is voltage applied to the sensing circuit, A-B represents the chemoresistor (sensing element), R_{L} is the load resistance, V_{RL} is the voltage drop generated by the load resistor (measured by the data acquisition board).

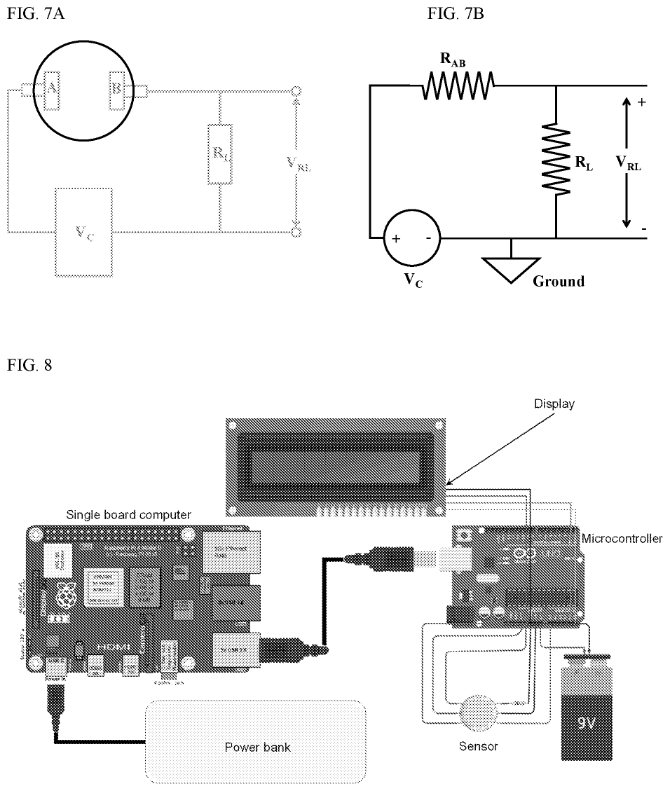

From FIG. 6, it is possible to separate the sensing circuit to perform some calculations and a further calibration, as shown by FIGS. 7A and 7B.

The chemoresistor sensor may be a calibrated chemoresistor sensor. The chemoresistor sensor may be calibrated in the air which provides easier implementation and is an improvement over other sensors that are calibrated with a gas. The chemoresistor sensor may be calibrated by applying a mathematical framework developed aimed to determine the value of the chemoresistor, R_{AB}, which corresponds to Rₛ in the master curve depicted by FIG. 3 and obtain a value of ammonia.

From FIGS. 7A and 7B, it is observed that the sensor contains two resistors connected in series. Thereby, the total resistance of the circuit can be expressed as Equation (1):

R_{T}=R_{L}+R_{AB} (1)

Since the system has an applied potential V_{C}, the current (I) can be expressed as per Ohm's law:

$$I = \frac{{V}_{C}}{{R}_{L} + {R}_{AB}} \qquad ( 2 )$$

Following with the Ohm's law, the voltage drop (V_{RL}) across the resistor R_{L} can be expressed as:

V_{RL}=1R_{L} (3)

By substituting Equation (2) into Equation (3) and solving for R_{AB}:

$${R}_{AB} = {R}_{L} ( \frac{{V}_{C}}{{V}_{RL}} - 1 ) \qquad ( 4 )$$

As noted, the voltage V_{RL} is measured by the data acquisition board, e.g., Arduino Uno®, with values between 0 and 1023 (A0). Consequently, V_{RL} can be expressed as:

$${V}_{RL} = {A}_{0} ( \frac{{V}_{C}}{1023} ) \qquad ( 5 )$$

Thus, by substituting Equation (5) into Equation (4) and after some mathematical rearrangements, the chemoresistor value can be expressed directly as a function of the load resistor (R_{L}) and the data acquisition board reading (A₀):

$${R}_{AB} = {R}_{S} = {R}_{L} ( \frac{1023}{{A}_{0}} - 1 ) \qquad ( 6 )$$

Finally, the value of R₀ is calulated. The value is obtained from FIG. 3 by observing that, in air with no ammonia, the value of Rₛ/R₀=3.6. Therefore, by using Equation 6:

$${R}_{0} = \frac{{R}_{L}}{3.6} ( \frac{1023}{{A}_{0}} - 1 ) \qquad ( 7 )$$

Hence, the data acquisition board may be programmed to perform a calibration before an actual reading. The data acquisition board may take about 120 readings in air and averages them to yield A₀ for Equation (7). After that, Equation (6) is used to measure Rₛ; then the ratio Rₛ/R₀ is obtained and the value of ppm of ammonia (VCI) is calculated from FIG. 3.

A single board computer (SCB) may be connected to the microcontroller by any means known in the art, such as the universal asynchronous receiver-transmitter (UART) protocol, general-purpose input/out (GPIO), universal serial bus (USB) protocol, etc. The SCB is programmed to receive the data generated by the microcontroller, store the data in a specific file format such as comma-separated value (CSV), tab-separated value (TSV), a common text file (TXT), or any other spreadsheet format file, such as ODT, XLS, XLSX, etc.

The SCB computer may be powered by an external power bank. It may be a bank with 12,000 mAh, and an output of 5V and 2.1 A. The data acquisition board may be an Arduino Uno® connected via USB to a Raspberry Pi 4. The sensing element can be an MQ-135 sensor connected to the Arduino Uno® as shown in FIG. 8 (image from https://upload.wikimedia.org/wikipedia/commons/5/51/RaspberryPi_Model_4B.svg). The complete system is depicted by FIG. 8.

A VCI measuring system includes a sensing element, and a data acquisition board, which serves as a microcontroller. The sensing element may be coupled to the data acquisition board by any means known in the art, for example by, a flexible transmission wire. The sensing element may include a socket or circuit board, and a chemoresistor sensor including a gas sensor, e.g., a metal oxide semiconductor gas sensor, that changes its resistance in the presence of certain gases. The sensing element may be positioned within any enclosed system that contains VCI.

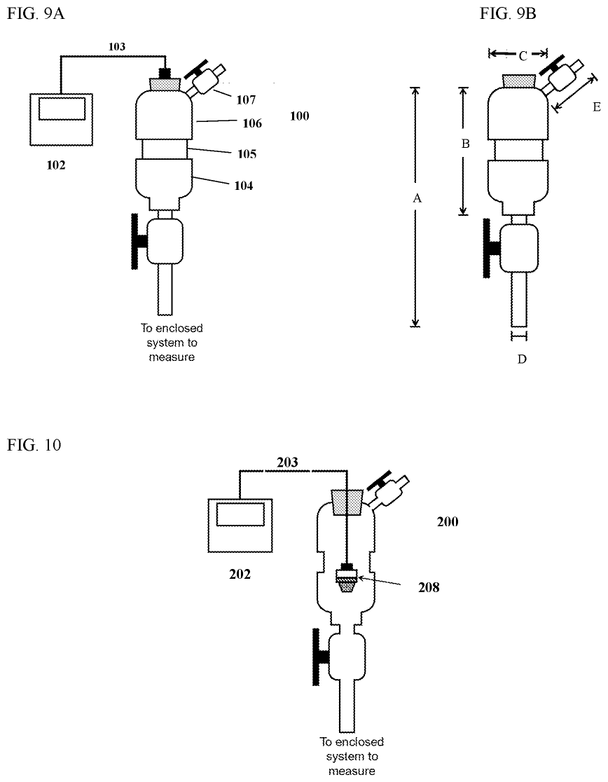

The sensing element may be enclosed within a head. This may protect the sensing element from damage. A head 100, e.g., as depicted in FIG. 9A, may include a PVC reductor 104, PVC tube 105, and an end cap 106 coupled to a valve to airspace 107. The use of pipes and valves is designed to generate convection and measure the VCI, while concurrently protecting the chemoresistor sensor from direct contact with liquid coming from a measuring line. A flexible transmission wire 103 and data acquisition board 102 are also shown in FIG. 9A

The length of the head (A in FIG. 9B) may be about 9 inches to about 15 inches, or about 12 inches, and the width (or diameter) of the head (C in FIG. 9B) may be about 2 inches to about 4 inches, or about 2.5 inches. The length of the extension containing the valve to air space (E in FIG. 9B) may be about 1 inch to about 4 inches, or about 2 inches. The length of the portion for encasing the sensing element, including the end cap, PVC tube and PVC reductor (B in FIG. 9B) may be about 4 inches to about 10 inches, or about 6 inches, The width of the base of the head (D in FIG. 9B) may be about 0.5 inches to about 2 inches, or about 1 inch. The position of the sensing element 208 within the head 200 is shown, for example, in FIG. 10. As shown therein, a portion of the flexible transmission wire 103 remains outside of the head and is coupled to the data acquisition board 202.

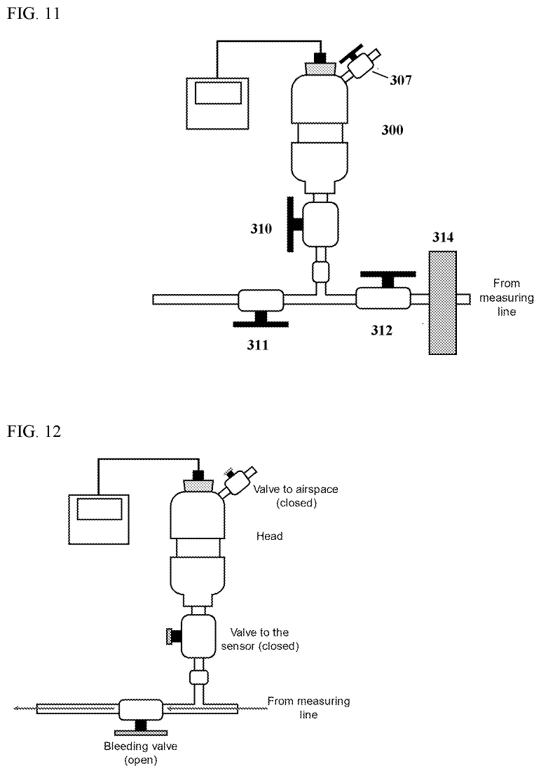

The head may be attached to a system to measure the concentration of VCI. The arrangement may include a valve to sensor, and a valve to air space. The head may be attached to an injection system to measure the concentration of VCI. When connected to one or more measuring lines of an injection system, the head may include a plurality of valves and a plurality of couplings. The arrangement may include a bleeding valve, a manifold valve, a valve to sensor, and a valve to air space. The valve to airspace and valve to sensor may be coupled directly to the head. FIG. 11 shows an arrangement of a head 300 connected to an injection manifold 314 and measuring line of an injection system, including:
a ‘T’ connector that is assembled to the manifold valve 312;
a bleeding valve 311;
a valve to sensor 310; and
a valve to air space 307.

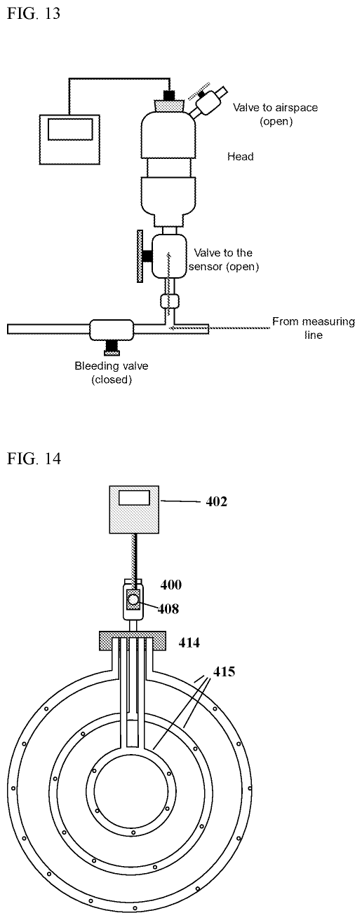

A method of measuring VCI using the sensing element enclosed within a head includes: maintaining the valve to the sensor and the valve to airspace in a closed position; opening the bleeding valve to purge any liquid coming from the measuring line (e.g., as shown in FIG. 12); closing the bleeding valve after liquid has been purged; and then opening the valve to the sensor and valve to the airspace to permit the flow of air containing VCI into the head for reading by the chemoresistor sensor (e.g., as shown in FIG. 13). In FIGS. 12 and 13, arrows represent the flow of air containing the VCI from the measuring line

A VCI measuring system for an injection system disclosed herein includes: one or more injection lines, wherein each of the injection lines has a circular portion and a plurality of linear portions; one or more measuring lines, wherein each of the measuring lines has a circular portion and a linear portion; an injection manifold coupled to the linear portions of the injection lines and coupled to the linear portion of the measuring line; and d) a chemoresistor sensor coupled to the injection manifold. The linear portion of the measuring line may be positioned between the plurality of linear portions of the injection lines. The chemoresistor sensor may be housed with a head and coupled to the injection manifold via an arrangement comprising a plurality of valves.

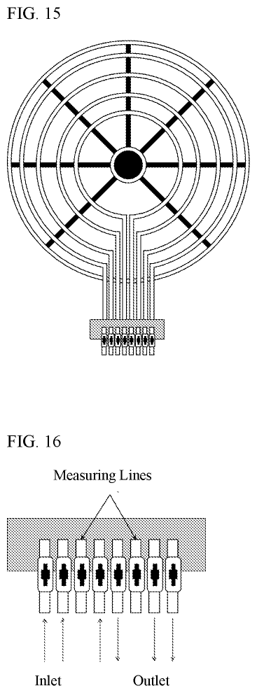

This system includes injection lines where the liquid containing a volatile corrosion inhibitor (VCI) is injected in liquid form into a sand bed underneath a tank. After dispersing through the sand, the VCI is diffused by the measuring line and travels through the measuring line towards the chemoresistor sensor, which optionally may be within a head. The head contains the chemoresistor sensor, and the chemoresistor sensor measures the concentration of the VCI. The VCI may be measured by the chemoresistor sensor which contains a resistor that varies its sensitivity in the presence of a gas, or, in this system, a VCI. FIG. 14 is an example of this system including a data acquisition board 402, a head 400 with a sensing element 408 therein, an injection manifold 414 and injection lines 415, FIGS. 15 and 16 show alternative arrangements for the injection lines and injection manifold.

Any injecting manifold may be used to measure the VCI concentration underneath a tank. An injection system may have the design shown in FIG. 10. The injection system may be made of PVC.

In this system, at least one injection line is not used to avoid cross-contamination and biased results, as shown in FIG. 16.

The injection lines may be made of any material known in the art and of any size. There may be one to five injection lines. There may be two injection lines with each containing a circular portion and a plurality of linear portions. Each injection line may include two linear portions which protrude from the circular portion in a parallel alignment with a space between each linear portion.

The measuring line may be made of any material known in the art and of any size. There may be one or two measuring lines with each containing a circular portion and a linear portion. The system may include one measuring line.

The circular portion of the injection lines and the circular portion of the measuring line may be arranged in concentric circles. There may be two injection lines with each having a circular portion, with one encircling the measuring line and the circular portion of the second injection line being arranged within the circular portion of the measuring line. There may be four linear portions of injection lines coupled to the injection manifold. There may be one or two linear portions of a measuring line coupled to the injection manifold. Any or all of the linear portions of the injection lines and linear portion of the measuring line may be coupled to the injection manifold.

The injection manifold may be coupled to the head or directly to the chemoresistor sensor by any means known in the art, for example, by one or more valves or piping.

The same procedure can be applied to any port, such as an injection port, an ER probe port, etc. and under tanks of any size that contains such ports (from 4 meters in diameter up to 60 meters (https://eurotankworks.com/storage-tanks/vertical-storage-tanks/)).

Also disclosed is a method of measuring a concentration of VCI in an injection system. The method may include: injecting a liquid containing VCI into a sand bed; diffusing the VCI in a measuring line within the sand bed; driving the VCI by convection from the measuring line into a head containing a chemoresistor sensor; calculating a voltage drop (or load resistance) in the chemoresistor sensor; and converting the voltage drop into the concentration of VCI. The concentration of VCI may be measured in ppm.

The method includes calculating a voltage drop or load resistance in the chemoresistor sensor. The voltage drop may be generated by the load resistor, and as shown in FIGS. 6 and 7.

A data acquisition board may be coupled to the head and convert the voltage drop into the concentration. The data acquisition board receives an output value, which is a calculated voltage drop generated by a load resistor measured in the chemoresistor sensor, and converts the value into a number, for example, between 0 and 1023 (hereafter A₀).

The method may include calibrating the chemoresistor sensor by any means disclosed above.

The chemoresistor sensor may include a heating element and a sensing element, and the method may include heating by the heating element of the head to a temperature of less than about 60° C. to create the convection.

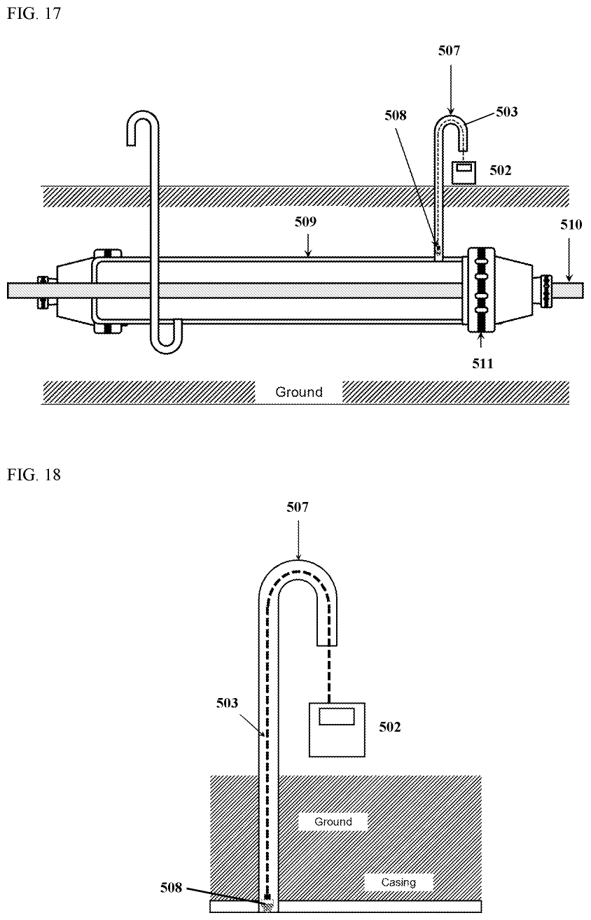

A VCI measuring system disclosed herein includes: a pipe casing surrounding a pipe; one or more vents in the pipe casing; and a VCI sensing device. The system is configured to permit the sensing element to be placed within one of the plurality of vents and positioned either within the pipe casing or in close proximity to the pipe casing such that the sensing element may measure the amount of VCI within the pipe casing. Close proximity is such that the sensing element is capable of measuring the VCI it may be within about 6 inches, or within about one foot of the pipe casing. The vent acts as a position of entry for the sensing element to extend into the pipe casing to measure the VCI. A flexible transmission wire may connect the sensing element to the data acquisition board and may be of any length needed to extend at least the length of the vent and into the airspace for connection to the data acquisition board. The pipe may be any utility pipe or underground pipe containing a fluid, such as gasoline, buried beneath the ground. The pipe casing may be any such pipe casing known for use in the art. A corrosion inhibitor in a gel filler matrix is conventionally used and injected into pipe casings through the vent connected to the lower end of the pipe casing. The VCI sensing element can be used to measure the VCI concentration in the pipe casing. An example of this system is shown in FIG. 17, which includes a data acquisition board 502, a sensing element 508, a flexible transmission wire 503, a vent 507, a pipe casing 509, a carrier pipe 510 and an end seal 511.

FIG. 18 shows the concept of using a vent 507 to reach the pipe casing 509, in more detail, and then measuring the VCI concentration in the casing.

Also disclosed is a method of measuring a concentration of VCI in a pipe casing. The pipe casing may encase an underground utility or fluid pipe. The pipe casing may have been filled with a corrosion inhibitor to protect the integrity of the underground pipe. The method may include: inserting a sensing element coupled to a flexible transmission wire into a vent connected to the pipe casing, wherein the sensing element includes a chemoresistor sensor; calculating a voltage drop (or load resistance) in the chemoresistor sensor due to the presence of VCI in the pipe casing; and converting the voltage drop into the concentration of VCI. The concentration of VCI may be measured in ppm. The VCI may be ammonia.

The features and advantages of the present disclosure are more fully shown by the following examples which are provided for purposes of illustration, and are not to be construed as limiting the invention in any way.

### EXAMPLES

### Example 1

The data acquisition board utilized in this example was an Arduino Uno®. According to official documentation (available at: https://www.arduino.cc/reference/en/language/functions/analog-io/analogread/), the Arduino Uno® contains an integrated 10-bit analog to digital converter and an operating voltage of 3.3 or 5 V. This implies that the Arduino Uno® can read a potential drop up to 5 V and convert the value into numbers between 0 and 1023 (hereafter A₀). The wiring is shown in detail in FIG. 6 and FIG. 7. The elements of the sensor are explained in detail as follows.

As depicted by FIG. 6, the gas detector (GAS1) contains a heating element and a resistor (R_{AB}) that varies its resistivity due to the presence of an amine-based volatile organic compound (VOC).

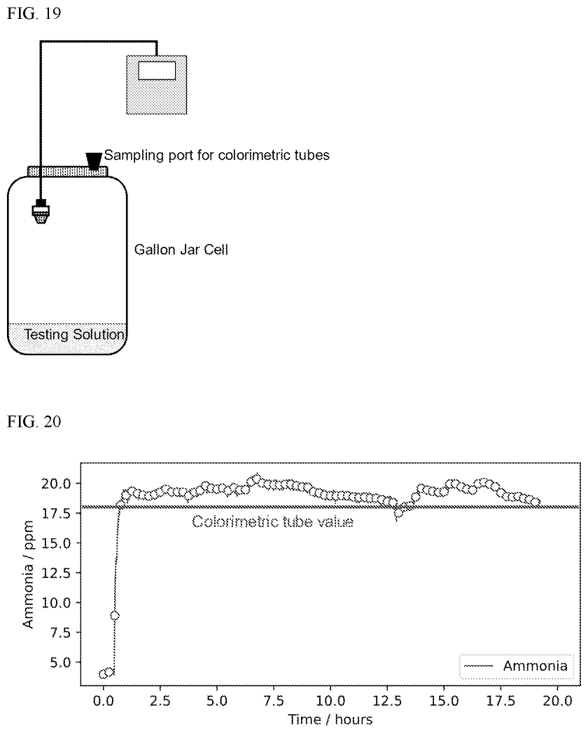

To determine the accuracy of the sensor, an experimental setup consisting of a gallon jar cell with 100 mL of a 5% solution of a corrosion inhibitor was used, as shown in FIG. 19. The lid had a sampling port for colorimetric tubes.

FIG. 20 shows the ammonia levels with time measured by the sensor (dots). After a stable average value was attained by the sensor (ca. 18.5 ppm), a Sensodyne™ colorimetric tube was utilized to measure the ammonia level in airspace. The value obtained was approximately 18 ppm of ammonia. These results indicate that the relative error of the sensor with respect to the colorimetric tube is around 3%.

The results in FIG. 20 show that the experimental setup worked effectively to measure the amount of VCI in the testing sample.

While there have been described what are presently believed to be various aspects and certain desirable embodiments of the disclosure, those skilled in the art will recognize that changes and modifications may be made thereto without departing from the spirit of the disclosure, and it is intended to include all such changes and modifications as fall within the true scope of the disclosure.

1. A VCI sensing head for measuring a concentration of VCI, comprising:
a VCI sensing device comprising:
a sensing element including a chemoresistor sensor;
a data acquisition board; and
a flexible transmission wire coupled at one end to the sensing element and coupled at the other end to the data acquisition board;
a plurality of valves; and
a plurality of piping;
wherein the sensing element is enclosed within the piping; and
wherein the sensing head is configured to be attached to an enclosed system containing VCI.

2. The VCI sensing head of claim 1, wherein the plurality of valves includes a valve to sensor, and a valve to air space.

3. The VCI sensing head of claim 1, wherein the plurality of valves includes a valve to sensor, a valve to air space, a bleeding valve and a manifold valve.

4. The VCI sensing head of claim 1, configured to be connected to one or more measuring lines of an injection system.

5. A VCI measuring system for an injection system comprising:
a) one or more injection lines, wherein each of the injection lines has a circular portion and a plurality of linear portions;
b) one or more measuring lines, wherein each of the measuring lines has a circular portion and a linear portion;
c) an injection manifold coupled to the linear portions of the injection lines and the linear portion of the one or more measuring lines; and
d) the VCI sensing head of any one of claims 1-4 coupled to the injection manifold;
wherein the linear portion of the measuring line is positioned between the plurality of linear portions of the injection lines.

6. The VCI measuring system of claim 5, wherein the circular portion of the one or more injection lines and the circular portion of the measuring line are arranged in concentric circles.

7. The VCI measuring system of claim 5, wherein the chemoresistor sensor comprises a heating element.

8. The VCI measuring system of claim 5, wherein the chemoresistor sensor includes a heating circuit and a sensing circuit.

9. The VCI measuring system of claim 5, wherein a load resistance in the chemoresistor sensor changes based on a concentration of VCI in the system.

10. The VCI measuring system of claim 5, wherein the chemoresistor sensor is calibrated to measure the concentration of VCI in the system

11. The VCI measuring system of claim 5, further comprising a data acquisition board coupled to the chemoresistor sensor.

12. The VCI measuring system of claim 5, wherein the data acquisition board is capable of converting the load resistance to a measurement of the concentration of VCI.

13. A method of measuring a concentration of VCI in an injection system comprising the steps of:
a) injecting a liquid containing VCI into a sand bed;
b) diffusing the VCI in a measuring line within the sand bed;
c) driving the VCI by convection from the measuring line into a head containing a chemoresistor sensor;
d) calculating a voltage drop in the chemoresistor sensor; and
e) converting the voltage drop into the measurement of the concentration of VCI.

13. The method of claim 13, further comprising calibrating the chemoresistor sensor before step a.

14. The method of claim 13, wherein a data acquisition board is coupled to the chemoresistor sensor and converts the voltage drop into the measurement of concentration.

15. The method of claim 13, wherein the concentration of VCI is measured in ppm.

16. The method of claim 13, wherein the chemoresistor sensor comprises a heating element, wherein the heating element heats the head to a temperature of less than about 60° C. to create the convection.

17. A VCI measuring system comprising:
a pipe casing surrounding an underground pipe, wherein the pipe casing includes one or more vents; and
a VCI sensing device comprising:
a sensing element including a chemoresistor sensor;
a data acquisition board; and
a flexible transmission wire coupled at one end to the sensing element and coupled at the other end to the data acquisition board.

18. The VCI measuring system of claim 17, wherein the sensing element is within one of the vents and is positioned within the pipe casing or in close proximity to the pipe casing.

19. The VCI measuring system of claim 17 or 18, wherein the sensing element is configured to measure the amount of VCI within the pipe casing.

20. A method of measuring a concentration of VCI in a pipe casing comprising:
inserting a sensing element coupled to a flexible transmission wire into a vent connected to the pipe casing, wherein the sensing element includes a chemoresistor sensor;
calculating a voltage drop in the chemoresistor sensor due to the presence of VCI in the pipe casing; and
converting the voltage drop into the concentration of VCI.
